(19) United States
(12) Patent Application Publication
(10) Pub. No.: US 2026/0168312 A1
(43) Pub. Date: Jun. 18, 2026

(54) DOOR CONTROL APPARATUS, VEHICLE CONTROL SYSTEM, DOOR CONTROL METHOD, AND NON-TRANSITORY COMPUTER READABLE MEDIUM

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/400,195

(22) Filed: Nov. 25, 2025

(30) Foreign Application Priority Data
Dec. 18, 2024 (JP) 2024-223594

(51) Int. Cl. E05F 15/73

(52) U.S. Cl. CPC E05F 15/73; E05F 2015/767; E05Y 2900/508

(57) ABSTRACT

A door control apparatus includes a controller for controlling the opening and closing of a door provided at an opening, based on captured data for an external area of a vehicle. The controller determines the presence or absence of a mobile object's intention to board the vehicle, from time-series data of the captured data, based on the positional relationship between the opening and the mobile object's movement direction. The controller varies the opening and closing timing of the door based on the determination result of the presence or absence of the mobile object's intention to board the vehicle.

### CROSS-REFERENCE TO RELATED APPLICATION

This application claims priority to Japanese Patent Application No. 2024-223594, filed on Dec. 18, 2024, the entire contents of which are incorporated herein by reference.

### TECHNICAL FIELD

The present disclosure relates to a door control apparatus for a vehicle, a vehicle control system, a door control method for a vehicle, and a non-transitory computer readable medium.

### BACKGROUND

As described in Patent Literature (PTL) 1, a boarding detection system for an elevator that estimates the presence or absence of a user's intention to board based on a time-series change in the user's position and the speed of the user's movement toward a door, and controls the opening and closing operation of the door based on the estimation result is known.

### CITATION LIST

### Patent Literature

PTL 1: JP 2017-124899 A

### SUMMARY

To control the opening and closing operation of a vehicle's door, it is conceivable to estimate the presence or absence of a person's intention to board who is present on a road facing the vehicle's door. However, even when the person on the road is moving toward the vehicle, it does not necessarily mean that the person is approaching to board the vehicle, but it is also possible that the person is passing by the vehicle. Therefore, in contrast to determining the presence or absence of a person's intention to board an elevator in front of the elevator, it is difficult to determine the presence or absence of the person's intention to board the vehicle when the person is moving toward the vehicle. It is required to control the opening and closing operation of the door appropriately.

It would be helpful to control the opening and closing of a vehicle's door as appropriate.

A door control apparatus according to an embodiment of the present disclosure includes a controller configured to control the opening and closing of a door provided at an opening of a vehicle, based on captured data for a captured range located in an external area relative to the opening. At least one mobile object is present in the captured range. The controller is configured to determine the presence or absence of the at least one mobile object's intention to board the vehicle, from time-series data of the captured data, based on a positional relationship between the opening and the at least one mobile object's movement direction. The controller is configured to vary the opening and closing timing of the door based on the determination result of the presence or absence of the intention to board the vehicle.

A vehicle control system according to an embodiment of the present disclosure includes the door control apparatus, the vehicle, and a camera configured to capture the captured data.

A door control method according to an embodiment of the present disclosure is a method for controlling the opening and closing of a door provided at an opening of a vehicle, based on captured data for a captured range located in an external area relative to the opening. At least one mobile object is present in the captured range. The door control method includes determining the presence or absence of the at least one mobile object's intention to board the vehicle, from time-series data of the captured data, based on the positional relationship between the opening and the at least one mobile object's movement direction. The door control method includes varying the opening and closing timing of the door based on the determination result of the presence or absence of the intention to board the vehicle.

A non-transitory computer readable medium according to an embodiment of the present disclosure stores a door control program. The door control program is a program for controlling the opening and closing of a door provided at an opening of a vehicle, based on captured data for a captured range located in an external area relative to the opening. At least one mobile object is present in the captured range. The door control program is configured to cause a processor to execute an operation including determining the presence or absence of the at least one mobile object's intention to board the vehicle, from time-series data of the captured data, based on the positional relationship between the opening and the at least one mobile object's movement direction. The door control program is configured to cause the processor to execute an operation including varying the opening and closing timing of the door based on the determination result of the presence or absence of the intention to board the vehicle.

The door control apparatus, the vehicle control system, the door control method, and the non-transitory computer readable medium according to an embodiment of the present disclosure can control the opening and closing of a vehicle's door as appropriate.

### BRIEF DESCRIPTION OF THE DRAWINGS

In the accompanying drawings:

FIG. 1 is a schematic diagram illustrating an example of a configuration of a vehicle equipped with a door to be controlled in a present disclosure;

FIG. 2 is a block diagram illustrating an example of a configuration of a vehicle control system according to the present disclosure;

FIG. 3 is a diagram illustrating an example of an image captured by a camera;

FIG. 4 is a schematic diagram explaining the determination of moving object blocks;

FIG. 5 is a side view illustrating an example of a captured range in which people are present;

FIG. 6 is a schematic diagram illustrating a captured image corresponding to FIG. 5;

FIG. 7 is a flowchart illustrating an example procedure of a door control method according to the present disclosure; and

FIG. 8 is a flowchart illustrating an example procedure for pedestrian exclusion determination.

### DETAILED DESCRIPTION

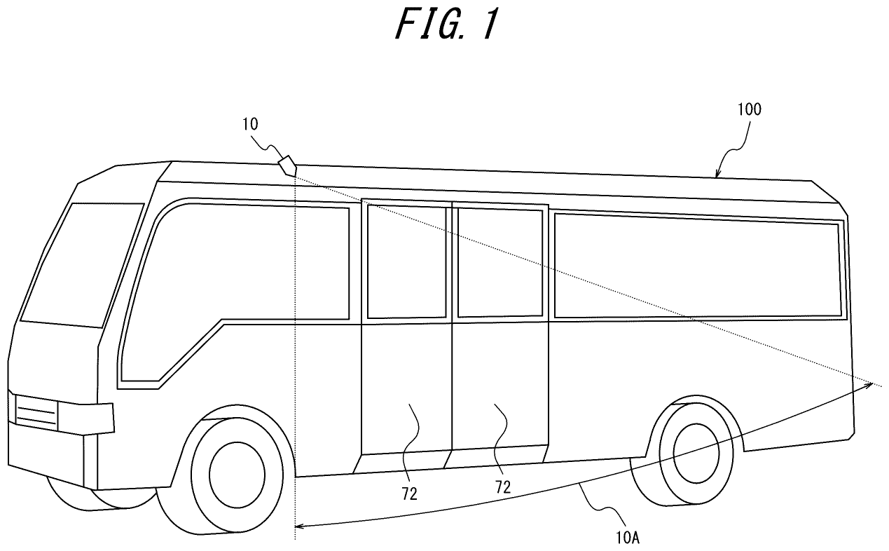

As illustrated in FIG. 1, when a vehicle 300 is equipped with a door 72 at an opening, passengers of the vehicle 300 board the vehicle 300 through the door 72 from an external area of the vehicle 300. The door 72 may be replaced with various other configurations that can be opened and closed.

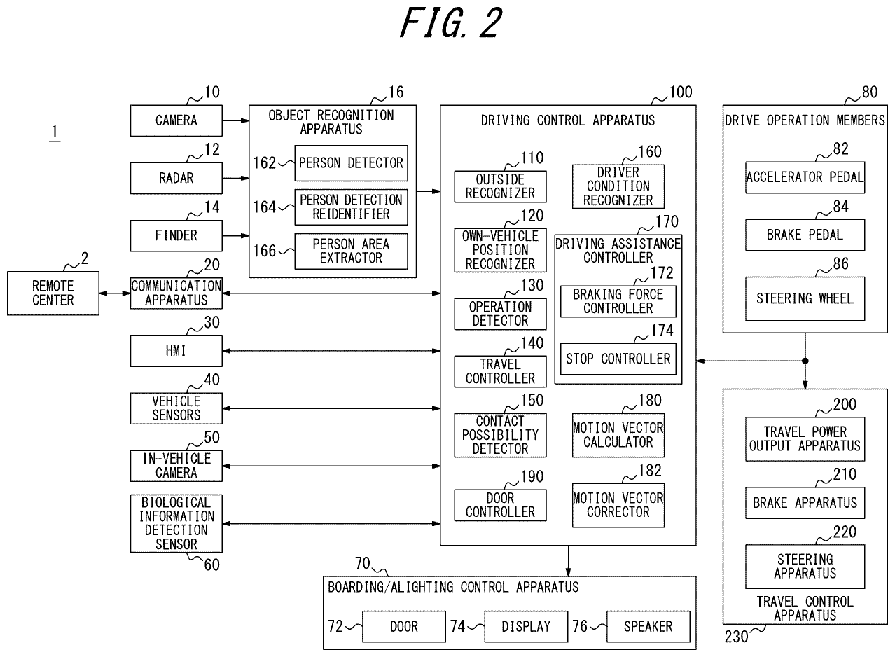

A vehicle control system 1 (see FIG. 2) captures the external area of the vehicle 300 around the door 72 using the camera 10, detects passengers present within a captured range 10A, as mobile objects, based on captured images, and controls the opening and closing of the door 72 by determining the presence or absence of passengers.

The passengers may rush into the vehicle 300. Around the vehicle 300, there are not only passengers who intend to rush into the vehicle 300 but also other people such as pedestrians who are not passengers. To enhance the accuracy of detecting rushing into the vehicle 300, in other words, to reduce false detections of rushing, it is necessary to appropriately execute determination based on the movement directions of people.

The vehicle control system 1 determines, from time-series data of captured images, whether a detected mobile object is a passenger or a person other than a passenger, such as a pedestrian, based on the positional relationship between the movement direction of a predetermined area containing the mobile object and the opening such as the door 72 of the vehicle 300. Based on the determination result of whether the mobile object is a passenger, the vehicle control system 1 determines whether the mobile object approaching the vehicle 300 intends to board the vehicle 300. Based on the determination result of the intention to board the vehicle 300, the vehicle control system 1 controls the opening and closing of the opening such as the door 72.

Hereinafter, an example of an embodiment of the vehicle control system 1 according to the present disclosure will be described.

### Example of Configuration of Vehicle Control System 1

As illustrated in FIG. 2, the vehicle control system 1 according to the present disclosure includes a driving control apparatus 100 and an object recognition apparatus 16.

### <Driving Control Apparatus 100>

The driving control apparatus 100 includes an outside recognizer 110, an own-vehicle position recognizer 120, an operation detector 130, a travel controller 140, and a contact possibility detector 150. The driving control apparatus 100 includes a driver condition recognizer 160, a driving assistance controller 170, a motion vector calculator 180, a motion vector corrector 182, and a door controller 190. The driving assistance controller 170 includes a braking force controller 172 and an stop controller 174.

The outside recognizer 110 recognizes the outside of the vehicle 300 based on the recognition result of the object recognition apparatus 16, which will be described later. The own-vehicle position recognizer 120 recognizes the position of the vehicle 300 based on satellite positioning data and the like. The operation detector 130 detects driving operations of the vehicle 300. The travel controller 140 controls the traveling of the vehicle 300. The travel controller 140 may control the vehicle 300 to travel by automated driving. The contact possibility detector 150 determines, based on information from the camera 10 and the like, the possibility of the vehicle 300 coming into contact with surrounding objects. The driver condition recognizer 160 recognizes the conditions of a driver of the vehicle 300 based on data detected by an in-vehicle camera 50 or a biological information detection sensor 60, which will be described later. The driving assistance controller 170 assists the driving of the vehicle 300 based on the state of the vehicle 300 or the recognition result of the conditions of the driver of the vehicle 300. The braking force controller 172 automatically brakes the vehicle 300 as needed. The stop controller 174 automatically stops the traveling of the vehicle 300 as needed.

The motion vector calculator 180 calculates a motion vector representing the movement direction of a mobile object detected around the vehicle 300. The motion vector corrector 182 corrects the motion vector.

The door controller 190 controls the opening and closing of the door 72 of the vehicle 300.

The driving control apparatus 100 may be configured with one or more processors or dedicated circuits to realize the functions of each component. In the present embodiment, the processors are general purpose processors or dedicated processors specialized for specific processing, but are not limited to these. The dedicated circuits may include, for example, field-programmable gate arrays (FPGAs) or application specific integrated circuits (ASICs).

The driving control apparatus 100 may be configured with a memory. The memory may be configured with, for example, a semiconductor memory, a magnetic memory, an optical memory, or the like, but is not limited to these. The memory may function, for example, as a main memory, an auxiliary memory, or a cache memory. The memory may be configured with an electromagnetic storage medium, such as a magnetic disk. The memory may be configured with a non-transitory computer readable medium. The memory stores any information or program to be used for operations of the driving control apparatus 100. The memory may store, for example, a system program, an application program, or the like. The memory may be included in a processor, a dedicated circuit, or the like.

The driving control apparatus 100 may be configured with an interface that communicates information, data, or the like with other components of the vehicle control system 1 or external apparatuses.

The interface may include a communication module configured to be communicable with other components or external apparatuses via a network. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface may be configured to be connectable to a communication module.

The interface may be equipped with terminals that correspond to a standard such as RS-232C or RS-485 so as to be directly connected to other components or external apparatuses.

The driving control apparatus 100 may be configured with an input device for accepting input of information, data, or the like from a user of the vehicle control system 1. The input device may be configured with, for example, a touch panel, a touch sensor, or a pointing device such as a mouse. The input device may be configured with a physical key. The input device may be configured with an audio input device, such as a microphone. The driving control apparatus 100 may be configured to be connectable to an external input device. The driving control apparatus 100 may be configured to be able to acquire, from the external input device, information or data inputted to the external input device.

The driving control apparatus 100 may be configured with an output device that outputs information or data to the user. The output device may include, for example, a display device that outputs visual information, such as images, or letters or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with light emitting devices, such as Light Emitting Diodes (LEDs) or Laser Diodes (LDs). The display device may be configured with various other devices. The output device may include, for example, an audio output device, such as a speaker, that outputs audio information e.g. voice. The output device is not limited to the above examples and may include various other devices. The driving control apparatus 100 may be configured to be connectable to an external output device. The driving control apparatus 100 may be configured to be able to output information or data to the external output device.

The driving control apparatus 100 may be configured with a single server apparatus or a plurality of server apparatuses capable of communicating with each other. The driving control apparatus 100 may be realized as a cloud server. The driving control apparatus 100 may be mounted in the vehicle 300. The driving control apparatus 100 may not be mounted in the vehicle 300. At least a part of the components of the driving control apparatus 100 may be mounted in the vehicle 300. At least a part of the components of the driving control apparatus 100 may not be mounted in the vehicle 300.

### <Object Recognition Apparatus 16>

The object recognition apparatus 16 includes a person detector 162, a person detection re-identifier 164, and a person area extractor 166. The object recognition apparatus 16 acquires data for detecting objects around the vehicle 300 from the camera 10, radar 12, and a finder 14, which will be described later, and recognizes a person present around the vehicle 300. The person detector 162 detects a person present around the vehicle 300. The person detection re-identifier 164 tracks the motion of the detected person. The person area extractor 166 extracts an area in which the person is present around the vehicle 300.

The object recognition apparatus 16 may be configured with one or more processors or dedicated circuits to realize the functions of each component. The processors or dedicated circuits may be configured similarly to the processors or dedicated circuits of the driving control apparatus 100. The object recognition apparatus 16 may include a memory. The memory may be configured similarly to the memory of the driving control apparatus 100. The object recognition apparatus 16 may be configured with an interface that communicates information, data, or the like with other components of the vehicle control system 1 or external apparatuses. The interface may be configured similarly to the interface of the driving control apparatus 100. The object recognition apparatus 16 may be configured as a part of the driving control apparatus 100.

The object recognition apparatus 16 may be configured with a single server apparatus or a plurality of server apparatuses capable of communicating with each other. The object recognition apparatus 16 may be realized as a cloud server. The object recognition apparatus 16 may be mounted in the vehicle 300. The object recognition apparatus 16 may not be mounted in the vehicle 300. At least a part of the components of the object recognition apparatus 16 may be mounted in the vehicle 300. At least a part of the components of the object recognition apparatus 16 may not be mounted in the vehicle 300.

### <Vehicle 300>

The vehicle control system 1 may further include various components that the vehicle 300 is equipped with. The vehicle 300 is equipped with the camera 10. The vehicle 300 may be equipped with the radar 12, the finder 14, a communication apparatus 20, a human machine interface (HMI) 30, vehicle sensors 40, the in-vehicle camera 50, and the biological information detection sensor 60, although being mandatory. The vehicle 300 includes drive operation members 80, a travel control apparatus 230, and a boarding/alighting control apparatus 70.

The camera 10 captures images around the vehicle 300. The range captured by the camera 10 is also referred to as a captured range 10A (see FIG. 1). The radar 12 and the finder 14 may detect an object around the vehicle 300 in forms other than images, such as point cloud data. Information around the vehicle 300 detected by the camera 10, the radar 12, and the finder 14 is output to the object recognition apparatus 16.

The communication apparatus 20 communicably connects a remote center 2, which monitors the state of the vehicle 300, and the driving control apparatus 100. The HMI 30 functions as an interface between the driver or the like of the vehicle 300 and the driving control apparatus 100.

The vehicle sensors 40 detect various states of the vehicle 300 and output the detection results to the driving control apparatus 100. The vehicle sensors 40 may be controlled by the driving control apparatus 100.

The in-vehicle camera 50 captures images of the interior of the vehicle 300. The in-vehicle camera 50 may image the driver or passengers of the vehicle 300. The in-vehicle camera 50 outputs the captured images to the driving control apparatus 100. The in-vehicle camera 50 may be controlled by the driving control apparatus 100.

The biological information detection sensor 60 detects biological information on the driver or the like of the vehicle 300. The biological information may include, for example, heart rate or blood pressure. The biological information may include the alertness state of the driver of the vehicle 300.

The drive operation members 80 include an acceleration pedal 82, a brake pedal 84, and a steering wheel 86. The drive operation members 80 are operated by the driver or the like of the vehicle 300. The vehicle 300 may not be equipped with the drive operation members 80 when controlled by automated driving.

The travel control apparatus 230 includes a travel power output apparatus 200, a brake apparatus 210, and a steering apparatus 220. The travel control apparatus 230 may operate in response to operations of the drive operation members 80. The travel control apparatus 230 may operate in response to instructions from the travel controller 140 or the driving assistance controller 170 of the driving control apparatus 100.

The boarding/alighting control apparatus 70 includes the door 72 of the vehicle 300. The opening and closing of the door 72 is controlled by the door controller 190. The boarding/alighting control apparatus 70 includes a display 74 and a speaker 76, which are not essential. The display 74 is installed outside the vehicle 300 to display destination information, a departure time, or the like of the vehicle 300 for passengers outside the vehicle 300. The speaker 76 is installed outside the vehicle 300 to output the destination information, the departure time, or the like of the vehicle 300 as audio information for the passengers outside the vehicle 300.

### Operation Example of Vehicle Control System 1

The vehicle control system 1 according to the present embodiment detects a passenger intending to rush into the vehicle 300, and controls the opening and closing of the door 72. The driving control apparatus 100 or the object recognition apparatus 16 of the vehicle control system 1 is an apparatus used to control the opening and closing of the door 72, and is also referred to as a door control apparatus. An operation example of the vehicle control system 1 will be hereinafter described.

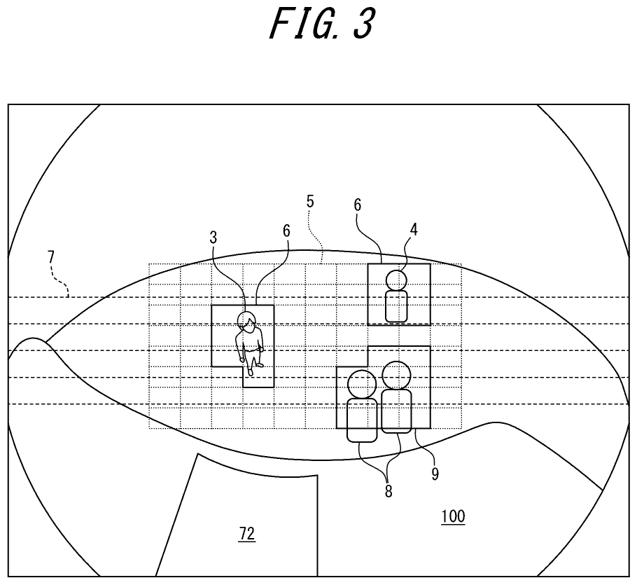

The object recognition apparatus 16 acquires a captured image of the captured range 10A from the camera 10. As illustrated in FIG. 3, the captured image includes images of objects located within the captured range 10A around the vehicle 300. This operation example assumes that mobile objects 3 and 4 who are present around the vehicle 300 are included in the captured image. The mobile object 3 is a person who intends to board the vehicle 300. The mobile object 4 is a person who does not intend to board the vehicle 300.

The object recognition apparatus 16 acquires images captured at multiple times by the camera 10. Specifically, the camera 10 captures the captured range 10A at both first and second times. The second time is a time that has elapsed a predetermined duration from the first time. The predetermined duration may be a frame rate when the camera 10 captures moving images. The image captured at the first time is also referred to as a first captured image. The image captured at the second time is also referred to as a second captured image.

The object recognition apparatus 16 recognizes a person such as the mobile object 3 or 4 included in the captured image by the person detector 162, and calculates the motion of the person by tracking the person by person detection re-identifier 164. The object recognition apparatus 16 outputs, to the driving control apparatus 100, the recognition result of the person, such as the mobile object 3 or 4 captured in the captured image, and the calculation result of the motion.

The object recognition apparatus 16 may determine a pedestrian among the detection people. The pedestrian refers to a person who does not intend to board the vehicle 300, that is, a mobile object that has no intention of boarding the vehicle 300. In other words, the object recognition apparatus 16 determines the presence or absence of the intention of each mobile object to board the vehicle 300, and determines a mobile object that has no intention of boarding the vehicle 300 as a pedestrian. The object recognition apparatus 16 may determine a person whose face is not facing the door 72 based on the orientations of detected people's faces, and determine that person as a pedestrian. To enhance the accuracy of face orientation determination, the object recognition apparatus 16 may acquire multiple images for people whose face orientations are to be determined, and determine the face orientations in each image. The object recognition apparatus 16 may determine who is not heading for the door 72 of the vehicle 300, based on an angle threshold for the detected people's time-series trajectories, and determine the person who is not heading for the door 72 as a pedestrian. The angle threshold is a value set as appropriate.

The object recognition apparatus 16 may be configured not to output the detection result of the person who has been determined as a pedestrian and the calculation result of that person's motion to the driving control apparatus 100. This eliminates the need for calculating motion vectors, which will be described later, for pedestrians. As a result, the vehicle control system 1 has a reduced processing load.

The motion vector calculator 180 of the driving control apparatus 100 calculates motion vectors, as feature values of an object, e.g., mobile object 3 or 4 captured in the captured image. As preparation for calculating the motion vectors, the motion vector calculator 180 divides the captured image into multiple blocks 5. In this operation example, the blocks 5 are arranged in a grid pattern. The manner of division into the blocks 5 is not limited to this. The motion vector calculator 180 calculates a motion vector in each divided block 5.

The motion vector of the object represents the direction and distance the object has moved from the position captured in the first captured image to the position captured in the second captured image. The value obtained by dividing the distance the object has moved by the predetermined time corresponds to the speed of the object. The motion vector calculator 180 may calculate the motion vector in each block 5 using a model, which outputs a motion vector on a block 5 basis when a first captured image and a second captured image are input. The model may be based on Dense Optical Flow or Deep Learning, for example.

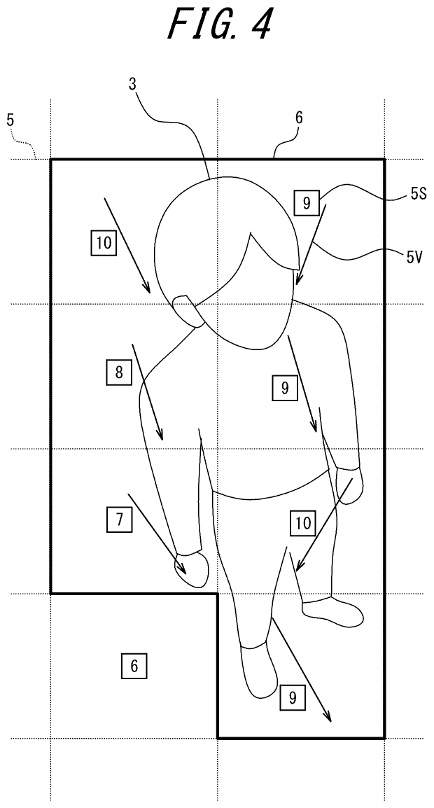

As illustrated in FIG. 4, the motion vector calculator 180 can calculate a motion vector, as a vector 5V, in each of blocks 5 in which a person as the mobile object 3 is captured. The motion vector represents the direction and distance a part of the mobile object 3 has moved.

The motion vector corrector 182 of the driving control apparatus 100 converts the motion vector of the object, e.g., mobile object 3 or 4 in each block 5, which is calculated by the motion vector calculator 180, into a scalar value of the object's motion. The scalar value of the object's motion represents the magnitude of the object's motion regardless of the direction of the object's motion. The scalar value of the object's motion is calculated as the length of the motion vector of the object, that is, the absolute value. In the example of FIG. 4, the motion vector corrector 182 can calculate a scalar value 5S converted from the vector 5V, which is the motion vector of the part of the mobile object 3 in each of the blocks 5 in which the mobile object 3 is captured.

The motion vector corrector 182 may extract motion vectors in each of which the absolute value of the angle difference between the direction of the object, which has been detected on a block 5 unit, heading for the door 72 of the vehicle 300 and the direction of the motion vector is within the angle threshold, and convert the extracted motion vectors into scalar values of the object's motion. The angle threshold is a value set as appropriate. Since the blocks 5 for which the motion vectors are converted into the scalar values are limited based on the angle threshold, objects moving in directions other than towards the door 72 of the vehicle 300, that is, objects unrelated to the opening and closing control of the door 72 are excluded from recognition. As a result, the vehicle control system 1 has a reduced processing load.

The motion vector corrector 182 determines blocks 5 with converted scalar values equal to or greater than a threshold, as moving object blocks. In this operation example, the threshold for the scalar values is set to 7. In this case, in the example of FIG. 4, the motion vector corrector 182 determines seven blocks 5 with scalar values 5S of 7 or more, as moving object blocks 6. The seven blocks 5 determined as the moving object blocks 6 are surrounded by a thick line in the example of FIG. 4. On the other hand, a block 5 with a scalar value 5S of 6 is not included in the moving object blocks 6.

The motion vector corrector 182 removes moving object blocks that are noise, among the determined moving object blocks. For example, the motion vector corrector 182 may remove, as noise, isolated moving object blocks 6, among moving object blocks 6 in the multiple blocks 5 into which the captured image is divided. Even in a case in which multiple moving object blocks 6 are adjacent, the motion vector corrector 182 may remove the multiple adjacent moving object blocks 6 as noise when the size of an area connecting the adjacent moving object blocks 6 is smaller than a size expected when a person is captured.

The motion vector corrector 182 may exclude the moving object blocks 6 by setting the magnitudes of the motion vectors of the moving object blocks 6 to be removed as noise to 0.

The motion vector corrector 182 may remove, as noise, moving object blocks 6 corresponding to a person recognized as a pedestrian by the object recognition apparatus 16. As illustrated in FIG. 3, when blocks of multiple pedestrians 8 are placed next to each other, the motion vector corrector 182 may determine that the multiple pedestrians 8 are moving as a group, and connect and regard the blocks of the multiple pedestrians 8 as one pedestrian area 9. Even in a case in which there are other blocks between the blocks of the multiple pedestrians 8, provided that there is no room for another person to enter between the multiple pedestrians 8, the object recognition apparatus 16 may connect and recognize the blocks of the multiple pedestrians 8 and the blocks therebetween as one pedestrian area 9. In other words, when the distance between captured ranges of multiple mobile objects determined not to intend to board the vehicle 300 is less than a predetermined value, the object recognition apparatus 16 may set an area including the captured ranges of the multiple mobile objects determined not to intend to board the vehicle 300 and blocks between the captured ranges of the multiple mobile objects determined not to intend to board the vehicle 300, as a pedestrian area 9. The predetermined value may be set as appropriate based on the size of the blocks. The motion vector corrector 182 may remove blocks 5 included in the pedestrian area 9 as noise. The motion vector corrector 182 may set the magnitudes of motion vectors of the blocks 5 included in the pedestrian area 9 to 0.

The motion vector corrector 182 determines moving object blocks 6 corresponding to a mobile object, from the remaining moving object blocks 6 after noise removal. Specifically, the motion vector corrector 182 groups adjacent moving object blocks 6 and determines the grouped moving object blocks 6 as the moving object blocks 6 corresponding to a mobile object. In the example of FIG. 4, the seven moving object blocks 6 are grouped as moving object blocks 6 corresponding to the mobile object 3.

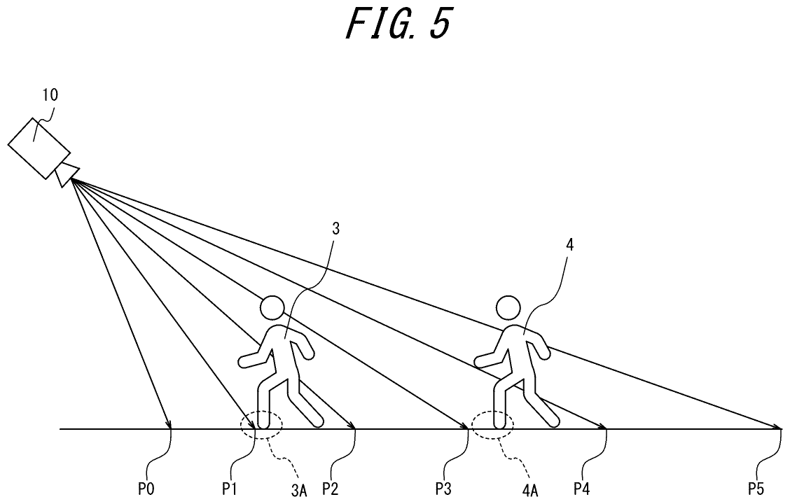

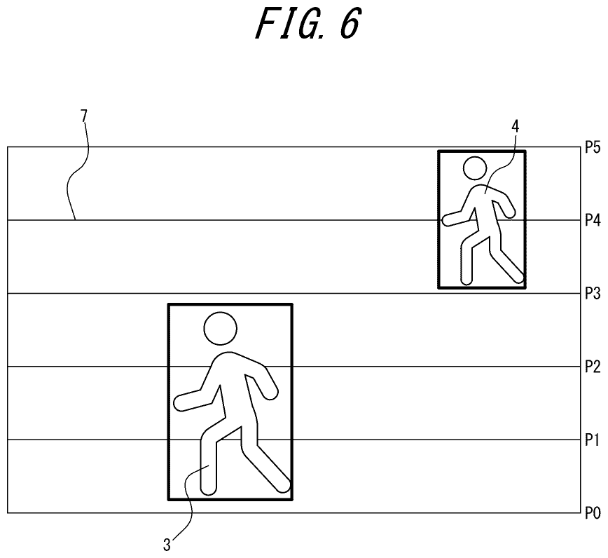

Here, an object located near the camera 10 and an object located far from the camera 10 are captured in different sizes from each other in a captured image. Specifically, the object located far from the camera 10 are captured smaller in the captured image than the object located near the camera 10. As illustrated in FIG. 3, stripes 7 extending horizontally are set at equal intervals in a vertical direction in the captured image. As illustrated in FIG. 5, in the actual captured range 10A, the farther from the camera 10, the wider the intervals between these stripes 7. As illustrated in FIG. 5, even when the mobile objects 3 and 4 have the same height, as illustrated in FIG. 6, the mobile object 4 located farther from the camera 10 is captured smaller than the mobile object 3 located closer to the camera 10 in the captured image. The stripes 7 in FIG. 5 and FIG. 6 are associated with reference numerals P0 to P5.

As described above, the magnitude of motion of an object captured at an upper portion in the captured image appears smaller than the magnitude of motion of an object at a lower portion in the captured image. Therefore, in order to reduce the influence of distance from the camera 10 to the object on the determination, the motion vector corrector 182 corrects the scalar values according to the position in the captured image.

As preparation for the correction of the scalar values, the motion vector corrector 182 determines the ground position of the mobile object. Specifically, the motion vector corrector 182 identifies a moving object block 6 located at the lowest edge of the captured image, for each group of the moving object blocks 6. As illustrated in FIG. 5, when viewing the captured range 10A of the camera 10 from the side, the closest ground position 3A of the mobile object 3 to the camera 10 and the closest ground position 4A of the mobile object 4 to the camera 10 are defined. The ground position 3A corresponds to a moving object block 6 located at the lowest edge of a group of moving object blocks 6 corresponding to the mobile object 3. The ground position 4A corresponds to a moving object block 6 located at the lowest edge of a group of moving object blocks 6 corresponding to the mobile object 4.

The motion vector corrector 182 corrects the scalar values according to the ground position of the mobile object. The object recognition apparatus 16 corrects the scalar values to be larger as the ground position of the mobile object is closer to the upper edge of the captured image, considering that the mobile object is located farther from the camera 10 and appears smaller. The motion vector corrector 182 may correct the scalar values by multiplying the scalar values, for example, by scalar value correction coefficients listed in the correction table illustrated in Table 1.

TABLE 1

| | P0 | P1 | P2 | P3 |
|---|---|---|---|---|
| B0 | 1 | 0 | 0 | 0 |
| B1 | 1.1 | 2 | 0 | 0 |
| . . . | 1.3 | 2.2 | 3 | 0 |
| B7 | 1.5 | 2.6 | 3.4 | 4 |

In the correction table of Table 1, B0 to B7 are reference numerals corresponding to respective rows when the captured image is divided into eight blocks 5 in the vertical direction. B0 corresponds to an area located at the lowest edge of the captured image, and an area closest to the camera 10. B7 corresponds to an area located at the highest edge of the captured image, and an area farthest from the camera 10. P0 to P3 correspond to the stripes 7 illustrated in FIG. 3, FIG. 5, and FIG. 6.

Specifically, the motion vector corrector 182 corrects the scalar values using the correction table of Table 1 as follows. When the lowest edge of the group of moving object blocks 6 is located at the stripe represented by P0, the motion vector corrector 182 multiplies scalar values of moving object blocks 6 in the row of B0, which is at the same height as P0, among the moving object blocks 6 by 1, multiplies scalar values of moving object blocks 6 in the row of B1 by 1.1, multiplies scalar values of moving object blocks in the rows of B2 to B6 by 1.3, and multiplies scalar values of moving object blocks 6 in the row of B7 by 1.5. When the lowest edge of the group of moving object blocks 6 is located at the stripe represented by P1, the motion vector corrector 182 multiplies scalar values of moving object blocks 6 in the row of B1, which is at the same height as P1, among the moving object blocks 6 by 2, multiplies scalar values of moving object blocks in the rows of B2 to B6 by 2.2, and multiplies scalar values of moving object blocks 6 in the row of B7 by 2.6. When the lowest edge of the group of moving object blocks 6 is located at the stripe represented by P2, the motion vector corrector 182 multiplies scalar values of moving object blocks 6 in the rows of B2 to B6 among the moving object blocks 6 by 3, and multiplies scalar values of moving object blocks 6 in the row of B7 by 3.4. When the lowest edge of the group of moving object blocks 6 is located at the stripe represented by P3, the motion vector corrector 182 multiplies scalar values of moving object blocks 6 in the row of B7, which is at the same height as P3, among the moving object blocks 6 by 4.

The correction table of Table 1 mentioned above is an example. The motion vector corrector 182 may appropriately generate a correction table based on the relationship between the size and position of an object captured in the captured image by the camera 10 and the actual size and position of the object in the captured range 10A.

The motion vector corrector 182 outputs the scalar values corrected as described above, to the door controller 190 of the driving control apparatus 100. The door controller 190 accumulates (sums), for each group of moving object blocks 6, the corrected scalar values of the moving object blocks 6 included in the group. The accumulated corrected scalar value represents the amount of movement of the object corresponding to the group of moving object blocks 6. For example, after the scalar values of the seven moving object blocks 6 corresponding to the mobile object 3 illustrated in FIG. 4 are corrected, the door controller 190 can accumulate the corrected scalar values to calculate the amount of movement of the mobile object 3.

When the amount of movement of the object is equal to or greater than a threshold, the door controller 190 determines that the object i.e. person intends to rush to board the vehicle 300. Upon determining that one or more persons captured in the captured image intend to rush to board the vehicle 300, the door controller 190 detects a rush to board the vehicle 300.

When not detecting a rush to board the vehicle 300, the door controller 190 keeps the door 72 open without closing the door 72. When detecting a rush to board the vehicle 300, the door controller 190 closes the door 72.

The door controller 190 may keep the door 72 open when detecting a rush to board the vehicle 300, and may close the door 72 when the duration of not detecting a rush to board the vehicle 300 exceeds a threshold.

### Example Procedure for Door Control Method

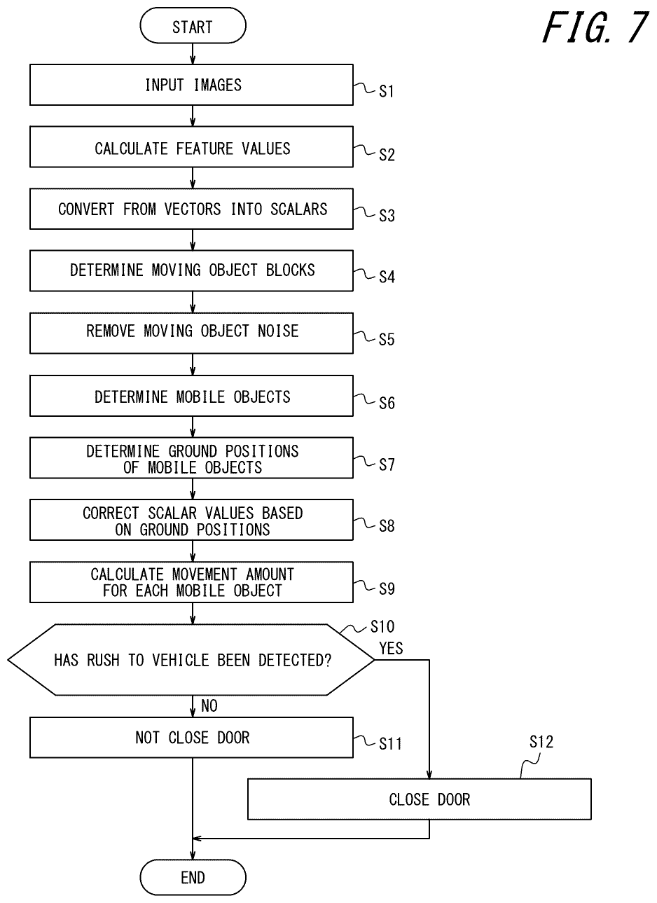

The vehicle control system 1 according to the present embodiment may execute a door control method that includes the procedure of the flowchart illustrated in FIG. 7, to determine the presence or absence of the intention of a mobile object present around the vehicle 300 to board the vehicle 300 and control the opening and closing of the door 72. The door control method may be realized as a door control program executed by a processor, such as the driving control apparatus 100 or the object recognition apparatus 16 included in the vehicle control system 1. The door control program may be stored in a non-transitory computer readable medium.

The object recognition apparatus 16 accepts, from the camera 10, input of images of a captured range 10A around the vehicle 300 (S1). The object recognition apparatus 16 may accept input of information on objects around the vehicle 300 from the radar 12 or the finder 14.

The object recognition apparatus 16 calculates feature values of objects captured in the captured images (S2). The object recognition apparatus 16 divides each captured image into multiple blocks, and calculates, as a feature value, a motion vector of an object in each block. The object recognition apparatus 16 calculates the direction and distance of movement of the object, based on a comparison between a first captured image at a first time and a second captured image at a second time, which is a predetermined time after the first time. The motion vector of the object represents the direction and distance the object has moved. The value obtained by dividing the distance the object has moved by the predetermined time corresponds to the speed of the object.

The object recognition apparatus 16 converts the motion vector of the object in each block into a scalar value of the object's motion (S3). The scalar value of the object's motion is a value that includes only the magnitude of motion, that is, the speed component of motion, without including the directional component of the object's motion. The object recognition apparatus 16 may extract, on a block-by-block basis, a motion vector in which the absolute value of the angle difference between the direction of heading for the door 72 of the vehicle 300 and the direction of the motion vector is within an angle threshold, and convert the extracted motion vector into a scalar value of the object's motion. The angle threshold is a value set as appropriate.

The object recognition apparatus 16 determines moving object blocks (S4). The object recognition apparatus 16 determines blocks with scalar values equal to or greater than a threshold, as moving object blocks. The threshold is a value set as appropriate.

The object recognition apparatus 16 removes moving object noise (S5). The object recognition apparatus 16 may exclude, from the moving object blocks, moving object blocks that are isolated from other moving object blocks.

The object recognition apparatus 16 determines mobile objects (S6). The object recognition apparatus 16 groups adjacent moving object blocks.

The object recognition apparatus 16 determines the ground positions of the mobile objects (S7). The object recognition apparatus 16 identifies, for each group of moving object blocks, a block located at the lowest edge of the image. The object recognition apparatus 16 determines the stripe number of the block located at the identified lowest edge.

The object recognition apparatus 16 corrects the scalar values based on the ground positions (S8). The object recognition apparatus 16 retrieves, from the correction table illustrated in above Table 1 or the like, a scalar value correction coefficient for each moving object block included in each group of moving object blocks, based on the stripe number. The object recognition apparatus 16 corrects the scalar values by multiplying the scalar value by the scalar value correction coefficient for each moving object block.

The object recognition apparatus 16 calculates the amount of movement for each mobile object (S9). The object recognition apparatus 16 accumulates the corrected scalar values of the moving object blocks for each group of moving object blocks. The scalar values accumulated on a group-by-group basis represent the amount of movement of each mobile object corresponding to the group of moving object blocks.

The driving control apparatus 100 determines whether a rush by a mobile object to board the vehicle 300 has been detected (S10). The driving control apparatus 100 determines that a mobile object corresponding to a group of moving object blocks with the amount of movement equal to or greater than a threshold intends to board the vehicle 300, and detects a rush by the mobile object to board the vehicle 300. In other words, when the amount of movement is equal to or greater than the threshold in at least one group of moving object blocks, the driving control apparatus 100 determines that a rush by the mobile object to board the vehicle 300 has been detected.

When a rush by a mobile object to board the vehicle 300 has not been detected (S10: NO), the driving control apparatus 100 controls the door controller 190 not to close the door 72 (S11). When a rush by a mobile object to board the vehicle 300 has been detected (S10: YES), the driving control apparatus 100 controls the door controller 190 to close the door 72 (S12). After executing the process of S11 or S12, the vehicle control system 1 ends the execution of the procedure in the flowchart of FIG. 7.

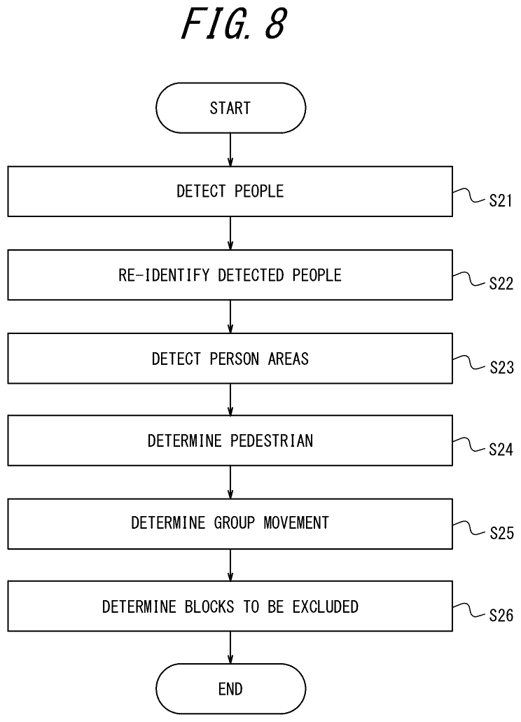

The object recognition apparatus 16 may execute, in the process (S2) of calculating the feature values in FIG. 7, a pedestrian exclusion determination procedure illustrated in FIG. 8.

The object recognition apparatus 16 detects, by the person detector 162, people captured in the captured images (S21). The object recognition apparatus 16 re-identifies the detected people by the person detection re-identifier 164, and tracks the people's motion (S22). The object recognition apparatus 16 detects areas in which the people are captured, using the person area extractor 166 (S23).

The object recognition apparatus 16 determines a pedestrian (S24). The pedestrian refers to a person who does not intend to board the vehicle 300. The object recognition apparatus 16 may determine who is not heading for the door 72 of the vehicle 300, based on an angle threshold for the detected people's time-series trajectories, and determine the person who is not heading for the door 72 as a pedestrian. The angle threshold is a value set as appropriate. The object recognition apparatus 16 may determine a person whose face is not facing the door 72 based on the orientations of detected people's faces, and determine that person as a pedestrian. To enhance the accuracy of face orientation determination, the object recognition apparatus 16 may acquire multiple images for people whose face orientations are to be determined, and determine the face orientations in each image.

The object recognition apparatus 16 determines group movement (S25). As illustrated in FIG. 3, when blocks of multiple pedestrians 8 are placed next to each other, the object recognition apparatus 16 may determine that the multiple pedestrians 8 are moving as a group, and connect and regard the blocks of the multiple pedestrians 8 as one pedestrian area 9. Even in a case in which there are other blocks between the blocks of the multiple pedestrians 8, provided that there is no room for another person to enter between the multiple pedestrians 8, the object recognition apparatus 16 may connect and recognize the blocks of the multiple pedestrians 8 and the blocks therebetween as one pedestrian area 9.

Returning to FIG. 8, the object recognition apparatus 16 determines blocks to be excluded (S26). The object recognition apparatus 16 excludes the blocks from the targets to be determined as moving object blocks in the flowchart of FIG. 7, by setting motion vectors in the blocks regarded as the pedestrian area to 0. After executing the process of S26, the object recognition apparatus 16 ends the execution of the procedure in the flowchart of FIG. 8.

### SUMMARY

As described above, the vehicle control system 1 according to the present disclosure can recognize the motion of a person captured in captured images around the vehicle 300, for each of blocks into which each captured image is divided. The vehicle control system 1 can determine whether the recognized person is a pedestrian, based on the positional relationship between the direction of motion of the person and the door 72 of the vehicle 300. The opening and closing of the door 72 is controlled based on the determination result of whether the person is a pedestrian. As a result, the opening and closing of the door 72 is controlled as appropriate. By recognizing the motion of the person on a block-by-block basis, noise is efficiently removed. As a result, the presence or absence of the intention of the person, who is captured in the captured images, to board the vehicle can be estimated with increased accuracy.

In the embodiment described above, the vehicle control system 1 recognizes the motion of a person using captured images, but may recognize the motion of a person using captured data of other forms, such as point cloud data detected by the radar 12 or the finder 14.

The execution subject of the operations of the vehicle control system 1 is not limited to the components described above. For example, the operations of the object recognition apparatus 16 may be executed by another apparatus such as the driving control apparatus 100. The operations of the motion vector calculator 180, the motion vector corrector 182, or the door controller 190 may be executed by various other components. The execution subject of the operations described above is collectively referred to as a controller.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

Examples of some embodiments of the present disclosure are described below. However, it should be noted that the embodiments of the present disclosure are not limited to these.
[Appendix 1] A door control apparatus comprising:
   a controller configured to control opening and closing of a door provided at an opening of a vehicle, based on captured data for a captured range located in an external area relative to the opening, at least one mobile object being present in the captured range,
   wherein the controller is configured to:
      determine presence or absence of the at least one mobile object's intention to board the vehicle, from time-series data of the captured data, based on a positional relationship between the opening and the at least one mobile object's movement direction; and
      vary opening and closing timing of the door based on a determination result of the presence or absence of the intention to board the vehicle.
[Appendix 2] The door control apparatus according to appendix 1, wherein when determining the presence or absence of the at least one mobile object's intention to board the vehicle, the controller is configured to determine the presence or absence of the at least one mobile object's intention to board the vehicle, based on a positional relationship between the opening and a movement direction of the captured range in which the at least one mobile object is present in the captured data.
[Appendix 3] The door control apparatus according to appendix 1 or 2, wherein when a distance between captured ranges of multiple mobile objects that have been determined, from the captured data, not to intend to board the vehicle is less than a predetermined value, the controller is configured to set, as a pedestrian area, an area including the captured ranges of the multiple mobile objects that have been determined not to intend to board the vehicle and blocks between the captured ranges, among multiple blocks divided in the captured data.
[Appendix 4] The door control apparatus according to any one of appendices 1 to 3, wherein the controller is configured to:
   calculate a vector including a direction of motion and a magnitude of motion of the mobile object being captured, in each of multiple blocks included in the captured range; and
   determine blocks with vectors meeting a condition as moving object blocks, and determine blocks with vectors not meeting the condition as blocks capturing a mobile object that has been determined not to intend to board the vehicle.
[Appendix 5] The door control apparatus according to appendix 4, wherein the controller is configured to remove, as noise, a block meeting a condition among the moving object blocks.
[Appendix 6] The door control apparatus according to appendix 5, wherein the controller is configured to group adjacent blocks among the moving object blocks, and recognize a group of the moving object blocks as the mobile object.
[Appendix 7] The door control apparatus according to any one of appendices 4 to 6, wherein the controller is configured to correct magnitudes of motion of the mobile object based on a ground position of the mobile object in the captured data.
[Appendix 8] The door control apparatus according to appendix 7, wherein the controller is configured to correct the magnitudes of motion of the mobile object by multiplying each magnitude of motion of the mobile object by a coefficient corresponding to a combination of the ground position of the mobile object in the captured data and a vertical position of the block capturing the mobile object.
[Appendix 9] A vehicle control system comprising:
   the door control apparatus according to any one of appendices 1 to 8;
   the vehicle; and
   a camera configured to capture the captured data.
[Appendix 10] A door control method for controlling opening and closing of a door provided at an opening of a vehicle, based on captured data for a captured range located in an external area relative to the opening, at least one mobile object being present in the captured range, the door control method comprising:
   determining presence or absence of the at least one mobile object's intention to board the vehicle, from time-series data of the captured data, based on a positional relationship between the opening and the at least one mobile object's movement direction; and
   varying opening and closing timing of the door based on a determination result of the presence or absence of the intention to board the vehicle.
[Appendix 11] The door control method according to appendix 10, wherein the determining of the presence or absence of the at least one mobile object's intention to board the vehicle includes determining the presence or absence of the at least one mobile object's intention to board the vehicle, based on a positional relationship between the opening and a movement direction of the captured range in which the at least one mobile object is present in the captured data.
[Appendix 12] The door control method according to appendix 10 or 11, comprising when a distance between captured ranges of multiple mobile objects that have been determined, from the captured data, not to intend to board the vehicle is less than a predetermined value, setting, as a pedestrian area, an area including the captured ranges of the multiple mobile objects that have been determined not to intend to board the vehicle and blocks between the captured ranges, among multiple blocks divided in the captured data.
[Appendix 13] The door control method according to any one of appendices 10 to 12, comprising:
   calculating a vector including a direction of motion and a magnitude of motion of the mobile object being captured, in each of multiple blocks included in the captured range; and
   determining blocks with vectors meeting a condition as moving object blocks, and determining blocks with vectors not meeting the condition as blocks capturing a mobile object that has been determined not to intend to board the vehicle.
[Appendix 14] The door control method according to appendix 13, comprising grouping adjacent blocks among the moving object blocks, and recognizing a group of the moving object blocks as the mobile object.
[Appendix 15] The door control method according to appendix 13 or 14, comprising correcting magnitudes of motion of the mobile object based on a ground position of the mobile object in the captured data.
[Appendix 16] The door control method according to appendix 15, comprising correcting the magnitudes of motion of the mobile object by multiplying each magnitude of motion of the mobile object by a coefficient corresponding to a combination of the ground position of the mobile object in the captured data and a vertical position of the block capturing the mobile object.
[Appendix 17] A non-transitory computer readable medium storing a door control program for controlling opening and closing of a door provided at an opening of a vehicle, based on captured data for a captured range located in an external area relative to the opening, at least one mobile object being present in the captured range, the door control program configured to cause a processor to execute operations, the operations comprising:
   determining presence or absence of the at least one mobile object's intention to board the vehicle, from time-series data of the captured data, based on a positional relationship between the opening and the at least one mobile object's movement direction; and
   varying opening and closing timing of the door based on a determination result of the presence or absence of the intention to board the vehicle.
[Appendix 18] The non-transitory computer readable medium according to appendix 17, wherein the determining of the presence or absence of the at least one mobile object's intention to board the vehicle includes determining the presence or absence of the at least one mobile object's intention to board the vehicle, based on a positional relationship between the opening and a movement direction of the imaging range in which the at least one mobile object is present.
[Appendix 19] The non-transitory computer readable medium according to appendix 17 or 18, wherein the operations include, when a distance between captured ranges of multiple mobile objects that have been determined, from the captured data, not to intend to board the vehicle is less than a predetermined value, setting, as a pedestrian area, an area including the captured ranges of the multiple mobile objects that have been determined not to intend to board the vehicle and blocks between the captured ranges, among multiple blocks divided in the captured data.
[Appendix 20] The non-transitory computer readable medium according to any one of appendices 17 to 19, wherein the operations include:
   calculating a vector including a direction of motion and a magnitude of motion of the mobile object being captured, in each of multiple blocks included in the captured range; and
   determining blocks with vectors meeting a condition as moving object blocks, and determining blocks with vectors not meeting the condition as blocks capturing a mobile object that has been determined not to intend to board the vehicle.

1. A door control apparatus comprising:
a controller configured to control opening and closing of a door provided at an opening of a vehicle, based on captured data for a captured range located in an external area relative to the opening, at least one mobile object being present in the captured range,
wherein the controller is configured to:
determine presence or absence of the at least one mobile object's intention to board the vehicle, from time-series data of the captured data, based on a positional relationship between the opening and the at least one mobile object's movement direction; and
vary opening and closing timing of the door based on a determination result of the presence or absence of the intention to board the vehicle.

2. The door control apparatus according to claim 1, wherein when determining the presence or absence of the at least one mobile object's intention to board the vehicle, the controller is configured to determine the presence or absence of the at least one mobile object's intention to board the vehicle, based on a positional relationship between the opening and a movement direction of the captured range in which the at least one mobile object is present in the captured data.

3. The door control apparatus according to claim 1, wherein when a distance between captured ranges of multiple mobile objects that have been determined, from the captured data, not to intend to board the vehicle is less than a predetermined value, the controller is configured to set, as a pedestrian area, an area including the captured ranges of the multiple mobile objects that have been determined not to intend to board the vehicle and blocks between the captured ranges, among multiple blocks divided in the captured data.

4. The door control apparatus according to claim 1, wherein the controller is configured to:
calculate a vector including a direction of motion and a magnitude of motion of the mobile object being captured, in each of multiple blocks included in the captured range; and
determine blocks with vectors meeting a condition as moving object blocks, and determine blocks with vectors not meeting the condition as blocks capturing a mobile object that has been determined not to intend to board the vehicle.

5. The door control apparatus according to claim 4, wherein the controller is configured to remove, as noise, a block meeting a condition among the moving object blocks.

6. The door control apparatus according to claim 4, wherein the controller is configured to group adjacent blocks among the moving object blocks, and recognize a group of the moving object blocks as the mobile object.

7. The door control apparatus according to claim 4, wherein the controller is configured to correct magnitudes of motion of the mobile object based on a ground position of the mobile object in the captured data.

8. The door control apparatus according to claim 7, wherein the controller is configured to correct the magnitudes of motion of the mobile object by multiplying each magnitude of motion of the mobile object by a coefficient corresponding to a combination of the ground position of the mobile object in the captured data and a vertical position of the block capturing the mobile object.

9. A vehicle control system comprising:
the door control apparatus according to claim 1;
the vehicle; and
a camera configured to capture the captured data.

10. A door control method for controlling opening and closing of a door provided at an opening of a vehicle, based on captured data for a captured range located in an external area relative to the opening, at least one mobile object being present in the captured range, the door control method comprising:
determining presence or absence of the at least one mobile object's intention to board the vehicle, from time-series data of the captured data, based on a positional relationship between the opening and the at least one mobile object's movement direction; and
varying opening and closing timing of the door based on a determination result of the presence or absence of the intention to board the vehicle.

11. The door control method according to claim 10, wherein the determining of the presence or absence of the at least one mobile object's intention to board the vehicle includes determining the presence or absence of the at least one mobile object's intention to board the vehicle, based on a positional relationship between the opening and a movement direction of the captured range in which the at least one mobile object is present in the captured data.

12. The door control method according to claim 10, comprising when a distance between captured ranges of multiple mobile objects that have been determined, from the captured data, not to intend to board the vehicle is less than a predetermined value, setting, as a pedestrian area, an area including the captured ranges of the multiple mobile objects that have been determined not to intend to board the vehicle and blocks between the captured ranges, among multiple blocks divided in the captured data.

13. The door control method according to claim 10, comprising:
calculating a vector including a direction of motion and a magnitude of motion of the mobile object being captured, in each of multiple blocks included in the captured range; and
determining blocks with vectors meeting a condition as moving object blocks, and determining blocks with vectors not meeting the condition as blocks capturing a mobile object that has been determined not to intend to board the vehicle.

14. The door control method according to claim 13, comprising grouping adjacent blocks among the moving object blocks, and recognizing a group of the moving object blocks as the mobile object.

15. The door control method according to claim 13, comprising correcting magnitudes of motion of the mobile object based on a ground position of the mobile object in the captured data.

16. The door control method according to claim 15, comprising correcting the magnitudes of motion of the mobile object by multiplying each magnitude of motion of the mobile object by a coefficient corresponding to a combination of the ground position of the mobile object in the captured data and a vertical position of the block capturing the mobile object.

17. A non-transitory computer readable medium storing a door control program for controlling opening and closing of a door provided at an opening of a vehicle, based on captured data for a captured range located in an external area relative to the opening, at least one mobile object being present in the captured range, the door control program configured to cause a processor to execute operations, the operations comprising:
determining presence or absence of the at least one mobile object's intention to board the vehicle, from time-series data of the captured data, based on a positional relationship between the opening and the at least one mobile object's movement direction; and
varying opening and closing timing of the door based on a determination result of the presence or absence of the intention to board the vehicle.

18. The non-transitory computer readable medium according to claim 17, wherein the determining of the presence or absence of the at least one mobile object's intention to board the vehicle includes determining the presence or absence of the at least one mobile object's intention to board the vehicle, based on a positional relationship between the opening and a movement direction of the captured range in which the at least one mobile object is present in the captured data.

19. The non-transitory computer readable medium according to claim 17, wherein the operations include, when a distance between captured ranges of multiple mobile objects that have been determined, from the captured data, not to intend to board the vehicle is less than a predetermined value, setting, as a pedestrian area, an area including the captured ranges of the multiple mobile objects that have been determined not to intend to board the vehicle and blocks between the captured ranges, among multiple blocks divided in the captured data.

20. The non-transitory computer readable medium according to claim 17, wherein the operations include:
calculating a vector including a direction of motion and a magnitude of motion of the mobile object being captured, in each of multiple blocks included in the captured range; and
determining blocks with vectors meeting a condition as moving object blocks, and determining blocks with vectors not meeting the condition as blocks capturing a mobile object that has been determined not to intend to board the vehicle.
